(19) United States
(12) Patent Application Publication
(10) Pub. No.: US 2022/0322858 A1
(43) Pub. Date: Oct. 13, 2022

(54) CONTAINER RETAINER DEVICE

(71) Applicant: Charles Macsherry, Tampa, FL (US)

(72) Inventor: Charles Macsherry, Tampa, FL (US)

(21) Appl. No.: 17/224,710

(22) Filed: Apr. 7, 2021

(51) Int. Cl. A47G 23/02; F16B 1/00

(52) U.S. Cl. CPC A47G 23/0225; F16B 1/00; F16B 2001/0035; A47G 2200/10

(57) ABSTRACT

Embodiments relate to a cradle having a continuous sidewall, an open top, and a bottom. The bottom is provided with at least one magnet attached thereto or secured within a pocket of the bottom. Some embodiments of the device include a bottom having an opening formed therein. Different embodiments of the bottom opening can have different shapes. Each bottom opening shape provides a specific bottom profile for the cradle. The bottom opening shape (or bottom profile) will dictate placement of the magnets. It is contemplated for the cradle, or at least the bottom, to be made of flexible material. Some embodiments of the cradle can be made from elastic material.

### TECHNICAL FIELD

Embodiments relate to a container retainer device including a cradle having a continuous sidewall, an open top, and a bottom, wherein the bottom is provided with at least one magnet attached thereto or secured within a pocket of the bottom.

### BACKGROUND

Conventional retaining systems are limited in their use in that they fail to provide the versatility required for retaining containers on various different types of surfaces. Conventional retaining systems can be appreciated from U.S. Pat. Nos. 3,524,614, 7,017,759, 8,398,155, 9,282,842, U.S. Patent Publication No. 2005/0006547, U.S. Patent Publication No. 2017/0086580, U.S. Patent Publication No. 2017/0086614, Magnetic Cup Caddy: https://www.amazon.com/Master-Magnetics-Magnetic-Cup-Caddy/dp/B0791MGF8K, Magnetic Bottle Holder: https://buy1more.com/product/Magnetic-bottle-holder/, Magnetic Water Bottle Holder: https://www.walmart.com/ip/Magnetic-Water-Bottle-Holder-With-Adiustable-Elastic-Sleeve-That-Fit-All-Sizes-Power-Ma(net-Adjustable-Belt-Universal-Compatibilit-for-Gym-Shoppong-/147359386, Magnetic Shampoo Bottle Holder: hips://www.livinginashoebox.com/wrap-and-hang-your-shampoo-bottle-on-a-magnet/, and Magnetic Kolder Kaddies: https://www.ualitylogoproducts.com/custom-koozies/magnetic-kolder-kaddv.htm.

The disclosure presented herein is designed to overcome at least one of the technical disadvantages identified above, although no necessarily limited to embodiments that do.

### SUMMARY

Embodiments relate to a container retainer system including a cradle having a continuous sidewall, an open top, and a bottom. The bottom is provided with at least one magnet attached thereto or secured within a pocket of the bottom. Some embodiments of the system include a bottom having an opening formed therein. Different embodiments of the bottom opening can have different shapes. Each bottom opening shape provides a specific bottom profile for the cradle. The bottom opening shape (or bottom profile) will dictate placement of the magnets. It is contemplated for the cradle, or at least the bottom, to be made of flexible material. Some embodiments of the cradle can be made from elastic material.

In use, an object (e.g., a bottle, a cup, etc.) is placed within the cradle via the open top. For instance, a condiment bottle is slid in the cradle so that the bottle's bottom rests against the cradle bottom. The elastic nature of the cradle allows for the cradle sidewall to receive and retain the object. The magnets in the cradle bottom allow the object to be removably secured to magnetic or magnetic attracting surfaces (e.g., a metal refrigerator door). The flexible nature of the cradle bottom, and in some cases the cradle bottom profile working in conjunction with the flexible nature of the material, facilitates accommodating: 1) different shaped objects (e.g., switching from a condiment bottle to a pill bottle); 2) expansion/contraction of the object (e.g., the bottle experiencing a change in temperature); and 3) uneven surfaces to which the cradle will be attached without degrading the ability of the magnets to secure the object to a magnetic surface.

Some embodiments include a base. The base can be a disk shaped member having an adhesive backing. The disk is made from magnetic material or magnetic attracting material. In use, the disk is secured to a non-magnetic surface (e.g., a wood cabinet) via its adhesive backing. The cradle can then be used to secure objects to the cabinet via removable securement to the base.

In an exemplary embodiment, a container retainer device includes a cradle having a continuous sidewall, an open top, a bottom, and a cavity, the cavity configured to receive an object. The device includes a plurality of magnets located within or on the bottom. At least the bottom of the cradle is made from a flexible material.

In some embodiments, the entire cradle is made from flexible material.

In some embodiments, the flexible material is silicon.

In some embodiments, the silicon has a shore rating of 40a.

In some embodiments, the continuous sidewall is dimensioned to form an interference fit with the object.

In some embodiments, the continuous sidewall has an inner surface and an outer surface. At least a portion of the inner surface and/or the outer surface has a surface ornamentation that is straight, tapered, undulated, ribbed, and/or textured.

In some embodiments, the surface ornamentation of the inner surface is the same as the surface ornamentation of the outer surface.

In some embodiments, the surface ornamentation of the inner surface differs from the surface ornamentation of the outer surface.

In some embodiments, the plurality of magnets is positioned about a periphery of the bottom.

In some embodiments, the plurality of magnets is positioned in a circular formation along a periphery of the bottom.

In some embodiments, the bottom has an inner surface and an outer surface. Any one or combination of the plurality of magnets is attached to the inner surface.

In some embodiments, the bottom has an inner surface and an outer surface. Any one or combination of the plurality of magnets is attached to the outer surface.

In some embodiments, any one or combination of the plurality of magnets are defiladed in a surface of the bottom.

In some embodiments, the device includes a plurality of pockets formed in or on the bottom, each pocket configured to receive and retain an individual magnet.

In some embodiments, any one or combination of the pockets is configured to defilade the magnet.

In some embodiments, the bottom has a bottom opening.

In some embodiments, the bottom has a bottom opening, and the bottom opening and the plurality of pockets form a bottom profile.

In some embodiments, the bottom profile forms a plurality of feet, each foot comprising a portion of the bottom leading to an individual pocket.

In some embodiments, each individual foot is deflectable in a direction that is independent from a deflection of another individual foot.

In some embodiments, the device includes a base having an adhesive backing, the base comprising a magnetic or magnetic attracting disk.

Further features, aspects, objects, advantages, and possible applications of the present invention will become apparent from a study of the exemplary embodiments and examples described below, in combination with the Figures, and the appended claims.

### BRIEF DESCRIPTION OF THE DRAWINGS

The above and other objects, aspects, features, advantages and possible applications of the present invention will be more apparent from the following more particular description thereof, presented in conjunction with the following drawings, in which:

FIG. 1 shows embodiments of the container retainer device being used to retain a container.

FIG. 2 shows various perspective and cross-sectional views of an embodiment of the container retainer device.

FIGS. 3-14 show various embodiments of the container retainer device, each with different dimensions, bottom profiles, pocket configurations, and number of magnets used.

### DETAILED DESCRIPTION

The following description is of an embodiment presently contemplated for carrying out the present invention. This description is not to be taken in a limiting sense, but is made merely for the purpose of describing the general principles and features of the present invention. The scope of the present invention should be determined with reference to the claims.

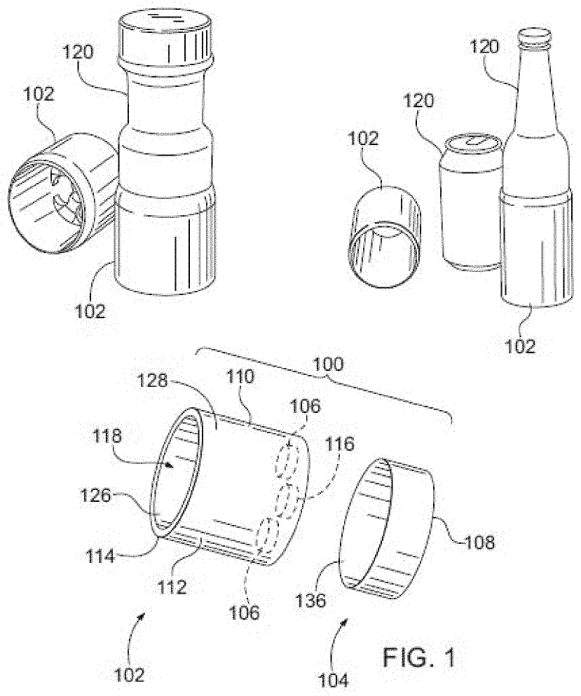

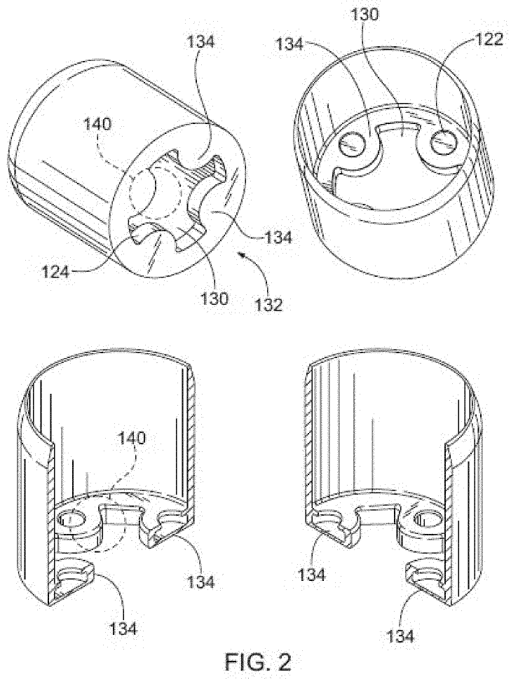

Referring to FIGS. 1-2, embodiments relate to a container retainer system 100. The system 100 can include a container retainer device 102. In some embodiments, the system 100 includes a container retainer device 102 with a base 104. In use, an object 120 (e.g., a bottle, a cup, etc.) is placed within the container retainer device 102 and held therein via an interference fit. Magnets 106 placed within a surface of the device 102 or secured to the device 102 allow the object 120 to be removably secured to magnetic surfaces or magnetic attracting materials (e.g., a ferromagnetic metal refrigerator door). The base 104 can be a disk shaped member having an adhesive backing 108. The disk is made from magnetic material or magnetic attracting material. In use, the base 104 is secured to a non-magnetic or non-magnetic attacking surface (e.g., a wood cabinet) via its adhesive backing 108. The device 102 can then be used to secure objects to the cabinet surface via removable securement to the base 104.

The container retainer device 102 includes a cradle 110 having a continuous sidewall 112, an open top 114, and a bottom 116. A cavity 118 is conformed within the open top 114 so as to allow for receipt of an object 120. The object 120 can be a container, such as a bottle, can, cup, etc. The container 120 can be a beverage cup, beverage bottle, tumbler, a pill bottle, a spice bottle, etc. The container 120 can be plastic, metal, glass, ceramic, polymer, etc. The container 120 is contemplated to an elongated container—i.e., having a container bottom, container body, container neck, and container top. The container top may have a cap or lid. In use, the container 120 is inserted into the cavity 118 such that the container bottom spearheads the insertion. Thus, the container bottom and the cradle bottom 116 would make contact or be adjacent each other when inserted.

The cradle 110 can be made from flexible, or at least semi-rigid material. This can include polymer, plastic, rubber, silicon, etc. While some portions may be made from non-flexible material, it is contemplated for the bottom 116 of the container 120 to be made from flexible material. In a preferred embodiment, the entire cradle is made from silicon. The silicon material can have a shore rating ranging from 30a to 50a, with 40a being preferred. The selection of silicon is also preferred because it can withstand temperatures of up to 220° F. without a loss in material degradation. This allows the device 102 to be used in high temperature environments (e.g., in commercial kitchens, next to grilling areas, outdoors in the open sun, etc.).

As noted earlier, the cradle 110 has a continuous sidewall 112, an open top 114, and a bottom 116 forming a cavity 118. The dimensions of the cradle 110 are such that the cavity 118 receives the container 120 and holds the container 120 within the cavity 118 via an interference fit—i.e., the inner diameter of the sidewall 112 can be the same or slightly smaller than that of the container 120.

Due to the formation of the cavity 118, the cradle bottom 116 has a cradle bottom inner surface 122 and a cradle bottom outer surface 124. In addition, the cradle sidewall 112 has a cradle sidewall inner surface 126 and a cradle sidewall outer surface 128. The cradle sidewall inner surface 126 and/or the cradle sidewall outer surface 128 can be any one or combination of straight, tapered, ribbed, undulated, textured, etc. For instance, the cradle sidewall inner surface 126 can be tapered so as to be flared at the container top 114 to allow for easy insertion of the container 120 but facilitate an interference fit at or near the cradle bottom 116. As another example, the cradle sidewall inner surface 126 can be ribbed to provide added gripping when securing the container 120 therein. As another example, the cradle sidewall outer surface 128 can be ribbed to provide added gripping for a user when handling the device 102.

The cradle 110 is provided with at least one magnet 106 attached thereto (e.g., attached via adhesive) or secured within (e.g. molded within the cradle 110, placed within pockets 134 formed in the cradle 110, etc.) the cradle bottom 116. The magnet(s) 106 can be located anywhere on the cradle bottom 116, but it is contemplated for the magnet(s) 106 to be located at a periphery of the cradle bottom 116. Preferably, the device 102 has a plurality of magnets 106, each individual magnet 106 located at a periphery of the cradle bottom 116. For instance, the plurality of magnets 106 can be positioned in a circular formation along a periphery of the cradle bottom 116. Locating the magnets 106 in a circular formation along the periphery provides for increased stability and hold strength, as compared to placing the magnet(s) 106 in the center (as in center-justified).

As noted herein, the cradle bottom 116 is preferably made of flexible material. This flexibility allows the cradle bottom 116 to be more conforming to surfaces—surfaces of the container bottom and surfaces to which the device 102 will be attached. For instance, the container bottom surface may be contoured, concave, convex, dented, etc. In addition, the surface to which the device 102 will be attached to may be contoured, concave, convex, dented, etc. The flexure of the cradle bottom 116 allows for the cradle material to better conform and thus accommodate such surfaces.

The cradle bottom 116 can be solid or have an opening 130 formed therein. The opening 130 can have a shape so as to form a cradle bottom profile 132. The opening shape can be circular, star, triangular, hexagonal, cross-shaped, etc.

The magnets 106 can be attached to the cradle bottom 116 via pockets 134 formed in the cradle bottom 116. The pockets 134 can be any one or combination of indentation-formations, cup-formations, sleeve-formations, defilade-formations, etc. The pockets 134 can be configured to any one or combination of encapsulate the magnets 106, defilade the magnets 106 (i.e., leave one side of the magnet exposed), etc. The defilade of the magnet 106 can be such that its exposed surface is at the cradle bottom inner surface 122, at the cradle bottom outer surface 124, or any combination of the two. The encapsulation of the magnet 106 can be such that one side or portion of a side is encapsulated with thicker material than that of the other side or another portion of the side. In some embodiments, the encapsulating or defilading pockets 134 can allow for removal and replacement of magnets 106. For instance, the pocket 134, or at least a portion of the pocket 134, can be dimensioned to be slightly smaller than that of the magnet 106 so as to form an interference fit therewith.

As noted herein, the opening 130 can form a cradle bottom profile 132. The profile 132 can dictate the placement of magnets 106. For instance, the profile 132 can be cross-shaped or star-shaped, wherein pockets 134 are formed at the intersection points. The flexible nature of the cradle bottom 116 (in particular the flexing of the pocket portions in the cross-shaped or star-shaped profile) and the bottom profile 132 dictating placement of the magnets 106 can provide for optimal securement, conformity to surfaces, and reduced weight. For instance, the flexure of the cradle bottom 116, along with the bottom profile 132, can allow for maximum conformation and accommodation of container bottom surfaces and surfaces to which the device 102 will be attached. If the container bottom or surface to which the device 102 is to be attached is deformed for some reason, this may cause cupping of the cradle bottom 116 had the cradle bottom 116 not be made from flexible material and/or have an opening 130 formed therein. This cupping would pull, or at least bias, the magnets 106 away from the surface to which they are intended to be attracted. Yet, the flexible nature of the cradle bottom 116 reduces or eliminates this. Furthermore, the bottom profile 132 having a star or cross formation with “feet” 140 within which the pockets 134 are formed, which allows for even more conformity by facilitating individual and independent flexure of each pocket 134. Thus, a cradle bottom 116 may have four pockets 134, for example, each formed in a “foot” 140 of the bottom profile 134 with an individual magnet 106 in each foot 140. Each foot 140 is like a nub of material that can be flexed (or deflected) in a direction that is independent of the direction another foot 140 is flexed. With such a configuration, the first pocket 134 can be flexed in a positive z-direction, the second pocket 134 can be flexed in a negative x-direction, and the third and fourth pockets 134 can be not flexed at all. The flexure or non-flexure is due to the individual magnets 106 being attracted to the uneven surface. This differentiated flexure provides maximum conformity, leading to maximum hold for the device 102.

It is contemplated for the pockets 134 to be sized and shaped to complement the size and shape of the magnet 106. The magnet 106 can be any size or shape. It is contemplated for the magnets to be rare earth magnets, such as a neodymium magnet. In a preferred embodiment, each magnet 106 is a 10×3 mm N52 neodymium magnet.

In a preferred embodiment, the pockets 134 are configured to defilade the magnets 106 such that the magnets 106 are exposed at the cradle bottom inner surface 122. This configuration not only provides for a clean look, but it also serves two additional functions. First, it prevents additional steps in manufacturing when the magnets 106 are installed—i.e., with the interference fit of a defilading pocket 134, the magnet 106 is secure once inserted. Second, the exposing end allows air to escape the pocket 134. If air could not escape, the pocket 134 would expand and contract as ambient temperature fluctuates, thereby decreasing hold strength for the device 102.

The bottom profile 132, dimension and strength of the magnets 106, and the material thickness of the cradle 110 are selected to meet predetermine design criteria, which can depend on the size, shape, and weight of the container 120. However, the overarching goal is to use the device 102 to retain a container 120 while the device is secured to a vertical surface—i.e., the container 120 is held at a horizontal position to the floor. Thus, the bottom profile 132, dimension and strength of the magnets 106, and the material thickness of the cradle 110 can be selected to achieve this goal for a particular container 120 or class of containers 120.

As noted herein, the system 100 can include a base 104. The base 104 can be used when the surface to which the device 102 is to be attached is not magnetic or not magnet attracting. The base 104 can be a disk shaped member having a cradle surface 136 and an adhesive backing 108. The adhesive backing 108 can be covered with a plastic or polymer film that can be peeled away when ready for use. After peeling the film away, the adhesive backing 108 is exposed and can be secure to a surface. The disk can be circular, square, hexagonal, etc. The disk is made from magnetic material or magnetic attracting material so that the magnets 106 of the cradle 110 can be attracted to the cradle surface 136 of the base 104. In use, the disk is secured to a non-magnetic surface (e.g., a wood cabinet) via its adhesive backing 108. Of course, the disk can also be secured to a magnetic or magnetic attracting surface, if desired. The cradle 110 can then be used to secure objects to the cabinet via removable securement to the base 104 at the cradle surface 136.

An exemplary use of the system 100 can involve inserting a container 120 into the cavity 118 such that the container bottom spearheads the insertion. The container 120 is inserted until an interference fit secures the container within the cradle 110. This can include inserting the container 120 until the container bottom is adjacent the cradle bottom inner surface 122. The device 102 can then be placed against a magnetic or magnetic attracting surface to secure the container 120 and device 102 thereto. The device 102 can be easily removed from the surface and reapplied to the same surface or another surface. The container 120 can also be easily removed and replaced with another container, as needed. In addition, or in the alternative, the base 104 can be secured to a non-magnetic or non-magnetic attracting surface. This can be done by exposing the adhesive backing 108 of the base 104 and securing the base 104 to the surface via the adhesive backing 108. The device 102 (with the container inserted therein) can then be placed against the cradle surface 136.

The system 100 can be used to stow containers 120 in an efficient and convenient manner. When stowed, the containers 120 are neatly stored but in a readily accessible fashion. The containers 120 can be stowed in up-side-down, in a horizontal manner, in a cabinet, under a vanity countertop, on the wall next to a night stand, etc. The cradle 110 dimensions and the cradle 110 being designed to slide over the bottom of the container 120 allows a user to easily see container tops or container side-labels for easy of viewing and quick assessment. The bottom profile 132 and the placement of magnets 106 provides for robust securement, allowing the system 100 to secure containers 120 to vehicles while moving, boats while sailing, etc.

Manufacturing the cradle 110 can be done via injection molding. With injection molding, a two piece mold is used, as opposed to a three or four piece mold. The simplicity of the mold itself means that the production process is faster, making the production timeline more manageable and also more affordable.

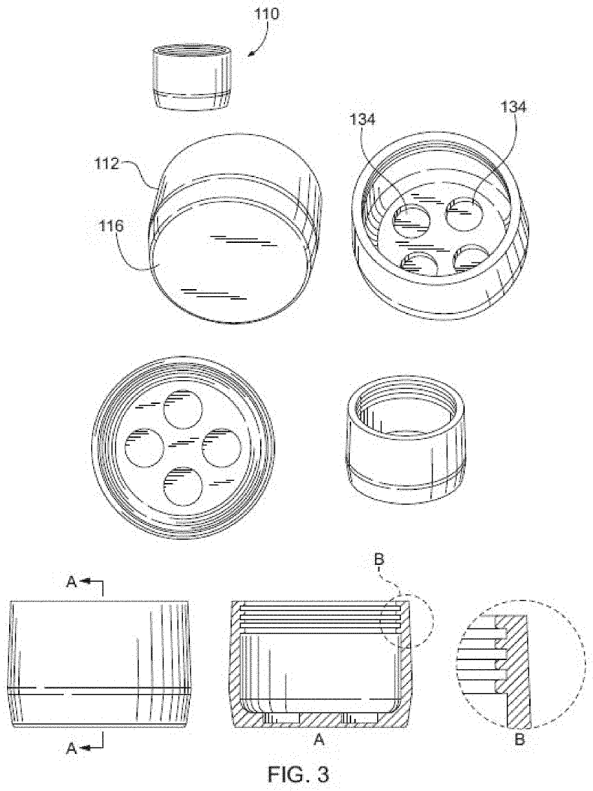

FIGS. 3-14 illustrate various embodiments of the device 102, each with different dimensions, bottom profiles 132, pocket 134 configurations, and number of magnets 106.

FIG. 3 shows an embodiment of the device 102 in which the bottom 116 is solid, the cradle sidewall inner surface 126 is ribbed, the cradle sidewall outer surface 128 at and near the bottom 116 is tapered, and the bottom profile 132 includes four pockets 134 configured to defilade magnets 106 in the inner surface 122 of the cradle bottom 116. The pockets 134 are provided about the periphery of the bottom 116, and are equally spaced from each other. The outer surface 124 of the cradle bottom 116 has a flat shape.

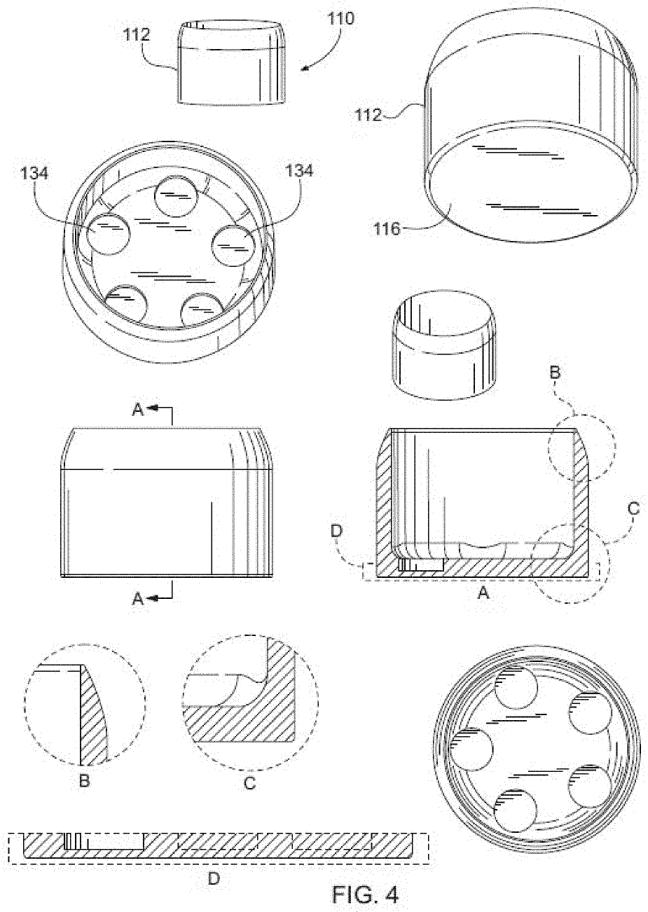

FIG. 4 shows an embodiment of the device 102 in which the bottom 116 is solid, the cradle sidewall inner surface 126 is smooth, the cradle sidewall outer surface 128 at and near the top 114 is tapered, and the bottom profile 132 includes five pockets 134 configured to defilade magnets 106 in the inner surface 122 of the cradle bottom 116. Generally, the more magnets 106, the better the cradle 110 is at resisting tipping. The pockets 134 are provided about the periphery of the bottom 116, and are equally spaced from each other. The outer surface 124 of the cradle bottom 116 has a concave shape to provide for natural suction and to prevent expansion from the container 120 interrupting magnet 106 hold.

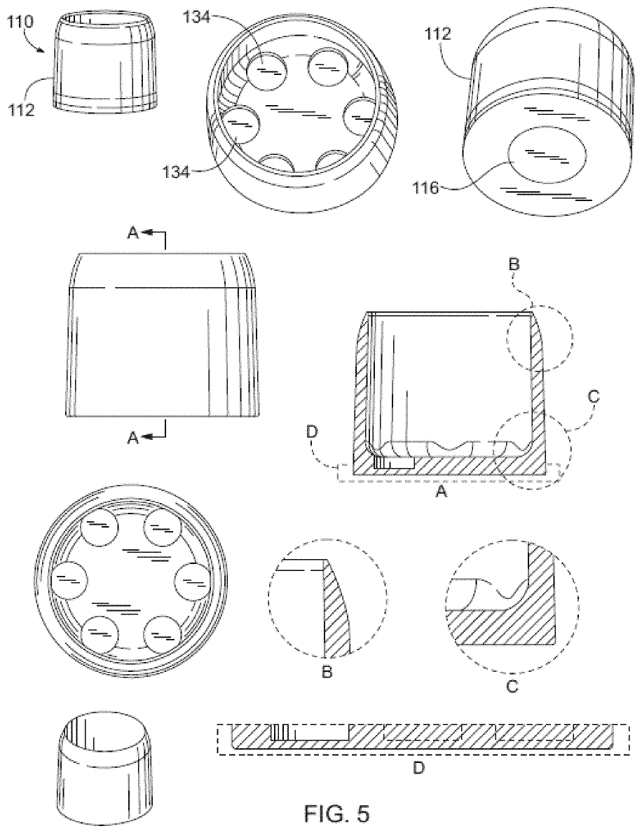

FIG. 5 shows an embodiment of the device 102 in which the bottom 116 is solid, the cradle sidewall inner surface 126 is smooth, the cradle sidewall outer surface 128 at and near the top 114 is tapered, and the bottom profile 132 includes six pockets 134 configured to defilade magnets 106 in the inner surface 122 of the cradle bottom 116. This cradle 110 is longer, and thus more magnets 106 may be better to assist with hindering tipping. The pockets 134 are provided about the periphery of the bottom 116, and are equally spaced from each other. The outer surface 124 of the cradle bottom 116 has a concave shape at the center positon only, as opposed to the concave shape being over the entire bottom 116. The smaller-diameter concave portion provides for natural suction and prevents expansion from the container 120 interrupting magnet hold, while also reducing wobble when loaded.

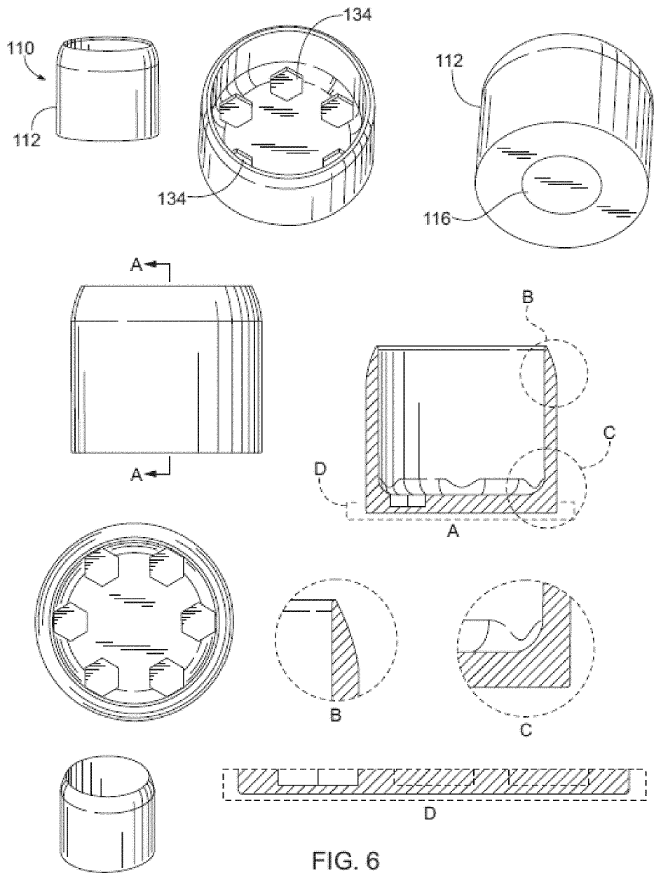

FIG. 6 shows an embodiment of the device 102 in which the bottom 116 is solid, the cradle sidewall inner surface 126 is smooth, the cradle sidewall outer surface 128 at and near the top 114 is tapered but slightly less tapered than that of the device 102 shown in FIG. 5, and the bottom profile 132 includes six pockets 134 configured to defilade magnets in the inner surface 122 of the cradle bottom 116. The pockets 134 are provided about the periphery of the bottom 116, and are equally spaced from each other. The outer surface 124 of the cradle bottom 116 has a concave shape at the center positon only.

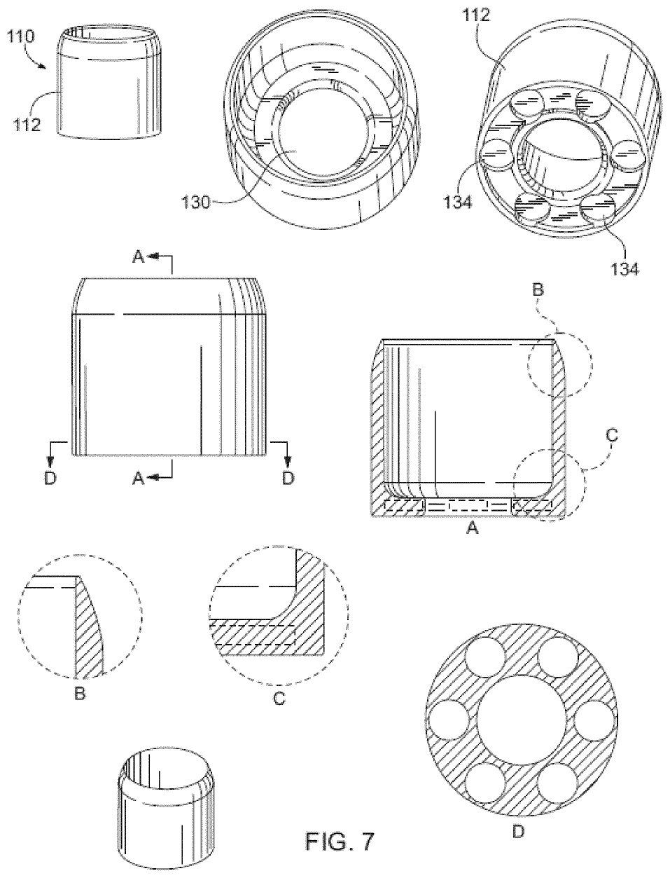

FIG. 7 shows an embodiment of the device 102 in which the bottom 116 is open, the cradle sidewall inner surface 126 is smooth, the cradle sidewall outer surface 128 at and near the top 114 is tapered, and the bottom profile 132 includes six pockets 134 configured to defilade magnets 106 in the outer surface of the cradle bottom 116. The pockets 134 are provided about the periphery of the bottom 116, and are equally spaced from each other. The open bottom 116 provides for material reduction and easier mounting to a container 120. The magnets 106 are defiladed in the outer surface 124 of the cradle bottom 116 to provide for maximum magnetic strength.

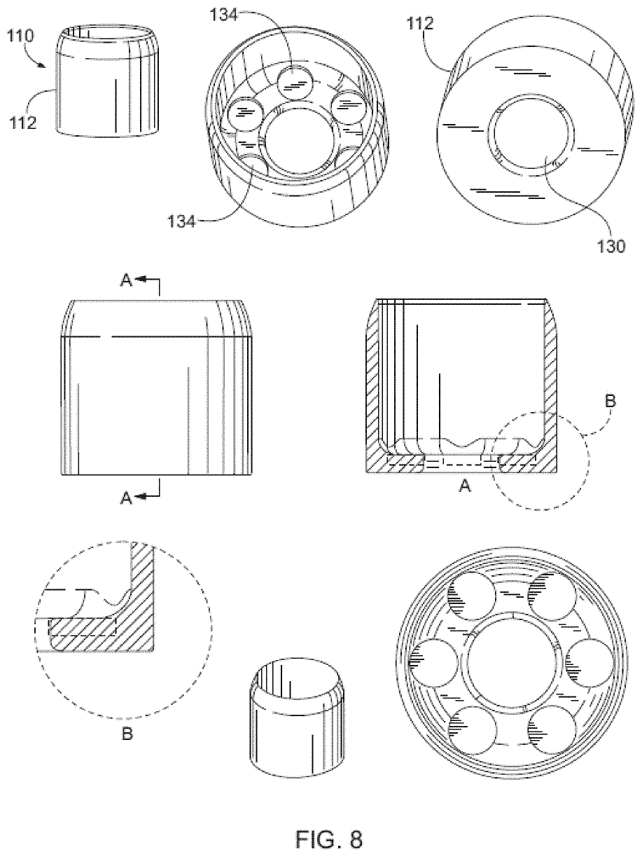

FIG. 8 shows an embodiment of the device 102 in which the bottom 116 is open, the cradle sidewall inner surface 126 is smooth, the cradle sidewall outer surface 128 at and near the top 114 is tapered, and the bottom profile 132 includes six pockets 134 configured to defilade magnets 106 in the inner surface 122 of the cradle bottom 116. The pockets 134 are provided about the periphery of the bottom 116, and are equally spaced from each other. The open bottom 116 provides for material reduction and easier mounting to a container 120. The magnets 106 are defiladed in the inner surface 122 of the cradle bottom 116.

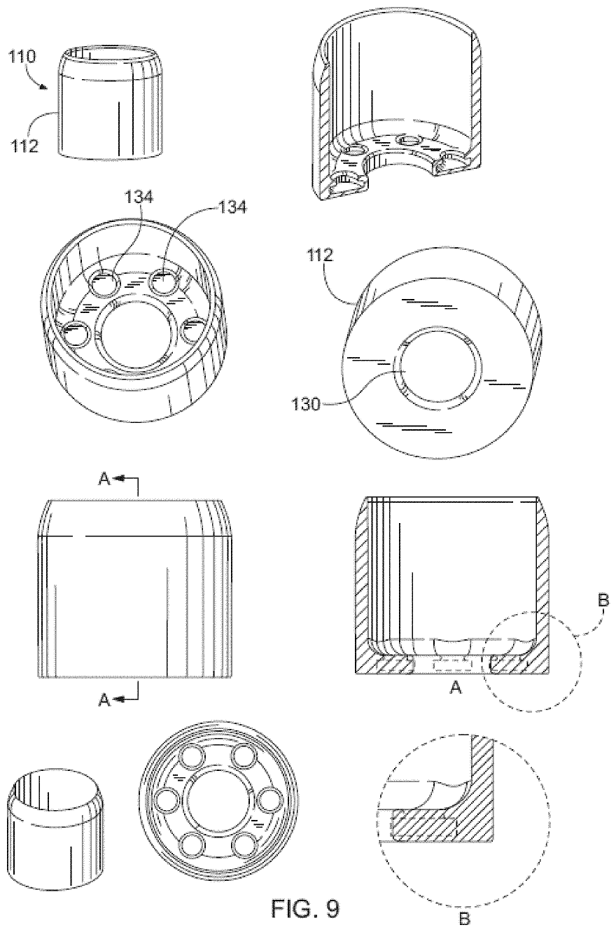

FIG. 9 shows an embodiment of the device 102 in which the bottom 116 is open, the cradle sidewall inner surface 126 is smooth, the cradle sidewall outer surface 128 at and near the top 114 is tapered, and the bottom profile 132 includes six pockets 134 configured to defilade magnets 106 in the inner surface 122 of the cradle bottom 116. The pockets 134 are provided about the periphery of the bottom 116, and are equally spaced from each other. The open bottom 116 provides for material reduction and easier mounting to a container 120. The magnets 106 are defiladed in the inner surface 122 of the cradle bottom 116. The pockets 134 are configured to receive the magnets 106 via a snap-in configuration.

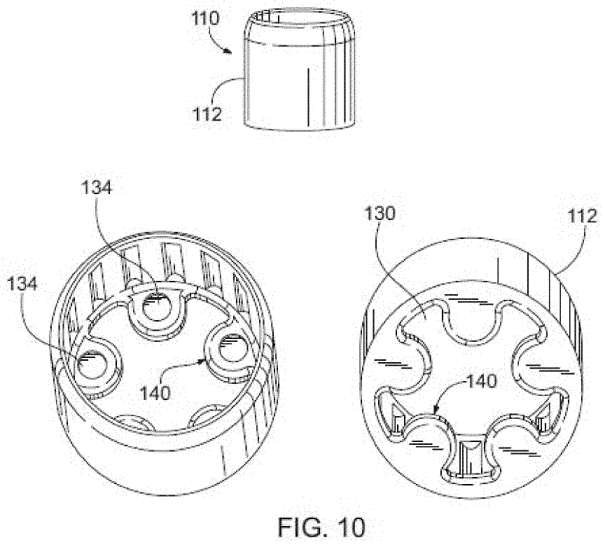

FIG. 10 shows an embodiment of the device 102 in which the bottom 116 is open, the cradle sidewall inner surface 126 is smooth, the cradle sidewall outer surface 128 at and near the top 114 is tapered, and the bottom profile 132 includes five pockets 134 configured to defilade magnets 106 in the inner surface 122 of the cradle bottom 116. The bottom profile 132 is star shaped. The pockets 134 are provided about the periphery of the bottom 116, and are equally spaced from each other. The open bottom 116 provides for material reduction and easier mounting to a container 120. The magnets 106 are defiladed in the inner surface 112 of the cradle bottom 116.

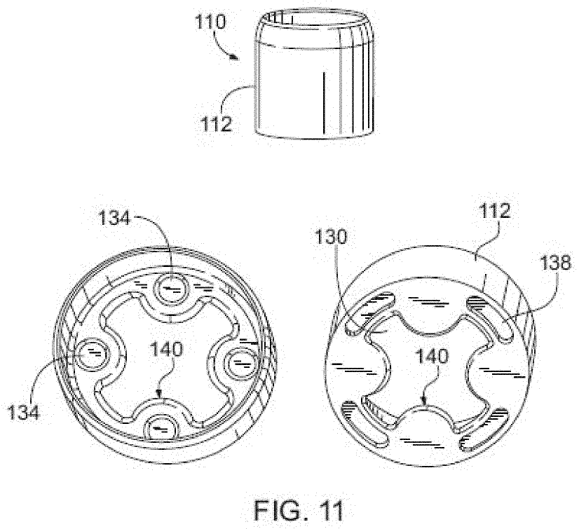

FIG. 11 shows an embodiment of the device 102 in which the bottom 116 is open, the cradle sidewall inner surface 126 is smooth, the cradle sidewall outer surface 128 at and near the top 114 is tapered, and the bottom profile 132 includes four pockets 134 configured to defilade magnets 106 in the inner surface 122 of the cradle bottom 116. The bottom profile 132 is cross shaped. The pockets 134 are provided about the periphery of the bottom 116, and are equally spaced from each other. The open bottom 116 provides for material reduction and easier mounting to a container 120. The magnets 106 are defiladed in the inner surface 122 of the cradle bottom 116. The bottom 116 has strips 138 removed to further achieve material reduction without degrading structural integrity.

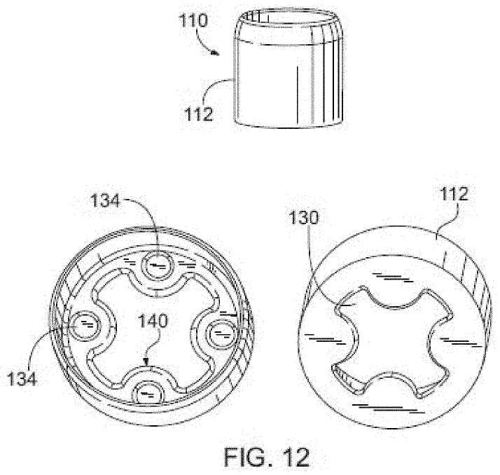

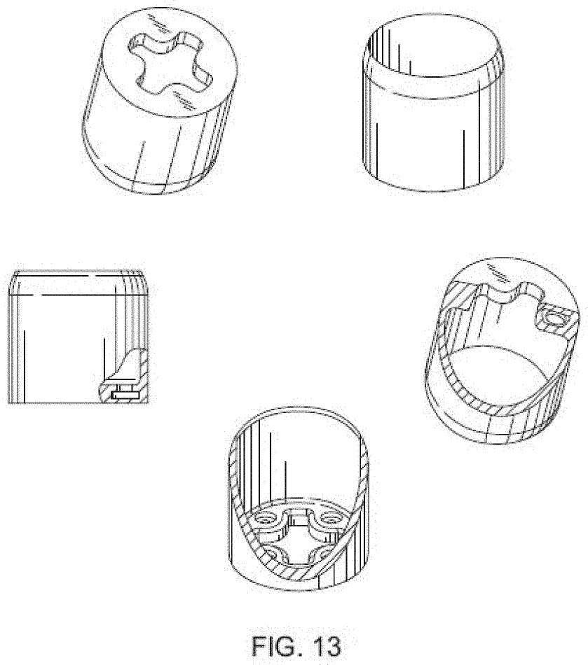

FIGS. 12-13 show an embodiment of the device 102 in which the bottom 116 is open, the cradle sidewall inner surface 126 is smooth, the cradle sidewall outer surface 128 at and near the top 114 is tapered, and the bottom profile 132 includes four pockets 134 configured to defilade magnets 106 in the inner surface 122 of the cradle bottom 116. The bottom profile 132 is cross shaped. The pockets 134 are provided about the periphery of the bottom 116, and are equally spaced from each other. The open bottom 116 provides for material reduction and easier mounting to a container 120. The magnets 106 are defiladed in the inner surface 122 of the cradle bottom 116.

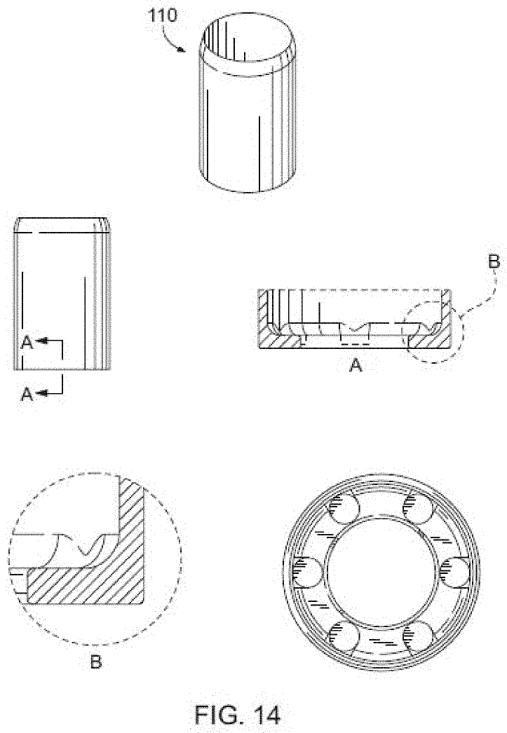

FIG. 14 shows an embodiment of the device 102 contemplated for used with larger containers 120, such as beverage containers. The bottom 116 is open, the cradle sidewall inner surface 126 is smooth, the cradle sidewall outer surface 128 at and near the top 114 is tapered, and the bottom profile 132 includes six pockets 134 configured to defilade magnets 106 in the inner surface 122 of the cradle bottom 116. The pockets 134 are provided about the periphery of the bottom 116, and are equally spaced from each other. The open bottom 116 provides for material reduction and easier mounting to a container 120. The magnets 106 are defiladed in the inner surface 122 of the cradle bottom 116.

It will be apparent to those skilled in the art that numerous modifications and variations of the described examples and embodiments are possible in light of the above teachings of the disclosure. The disclosed examples and embodiments are presented for purposes of illustration only. Other alternate embodiments may include some or all of the features disclosed herein. Therefore, it is the intent to cover all such modifications and alternate embodiments as may come within the true scope of this invention, which is to be given the full breadth thereof. Additionally, the disclosure of a range of values is a disclosure of every numerical value within that range, including the end points.

1. A container retainer device, comprising:
a cradle having a continuous sidewall, an open top, a bottom, and a cavity, the cavity configured to receive an object;
a plurality of magnets located within or on the bottom; and
a plurality of feet, each foot comprising a portion of the bottom;
wherein at least the bottom of the cradle comprises a flexible material.

2. The container retainer device recited in claim 1, wherein:
the entire cradle is made from flexible material.

3. The container retainer device recited in claim 1, wherein: the flexible material is silicone.

4. The container retainer device recited in claim 3, wherein:
the silicon has a shore rating of 40a.

5. The container retainer device recited in claim 1, wherein:
the continuous sidewall is dimensioned to form an interference fit with the object.

6. The container retainer device recited in claim 1, wherein:
the continuous sidewall has an inner surface and an outer surface; and
at least a portion of the inner surface and/or the outer surface has a surface ornamentation that is straight, tapered, undulated, ribbed, and/or textured.

7. The container retainer device recited in claim 6, wherein:
the surface ornamentation of the inner surface is the same as the surface ornamentation of the outer surface.

8. The container retainer device recited in claim 6, wherein:
the surface ornamentation of the inner surface differs from the surface ornamentation of the outer surface.

9. The container retainer device recited in claim 1, wherein:
the plurality of magnets is positioned about a periphery of the bottom.

10. The container retainer device recited in claim 1, wherein:
the plurality of magnets is positioned in a circular formation along a periphery of the bottom.

11. The container retainer device recited in claim 1, wherein:
the bottom has an inner surface and an outer surface; and
any one or combination of the plurality of magnets is attached to the inner surface.

12. The container retainer device recited in claim 1, wherein:
the bottom has an inner surface and an outer surface; and
any one or combination of the plurality of magnets is attached to the outer surface.

13. The container retainer device recited in claim 1, wherein:
any one or combination of the plurality of magnets are defiladed in a surface of the bottom.

14. The container retainer device recited in claim 1, further comprising:
a plurality of pockets formed in or on the plurality of feet, wherein each foot leads to an individual pocket, and wherein each pocket is configured to receive and retain an individual magnet.

15. The container retainer device recited in claim 14, wherein:
any one or combination of the pockets is configured to defilade the magnet.

16. The container retainer device recited in claim 1, wherein:
the bottom has a bottom opening.

17. The container retainer device recited in claim 14, wherein:
the bottom has a bottom opening; and
the bottom opening and the plurality of pockets form a bottom profile.

18. (canceled)

19. The container retainer device recited in claim 1, wherein:
each individual foot is deflectable in a direction that is independent from a deflection of another individual foot.

20. The container retainer device recited in claim 1, further comprising:
a base having an adhesive backing, the base comprising a magnetic or magnetic attracting disk.
